(19) United States
(12) Patent Application Publication
(10) Pub. No.: US 2007/0255738 A1
(43) Pub. Date: Nov. 1, 2007

(54) System, Method, and Computer-Readable Medium for Performing Data Structure Updates in a Multi-Processor System

(75) Inventor: Christopher J. D'Costa, Cary, NC (US)

Correspondence Address: HAYNES AND BOONE, LLP, 901 MAIN STREET, SUITE 3100, DALLAS, TX, 75202, US

(73) Assignee: Tekelec, Calabasas, CA (US)

(21) Appl. No.: 11/566,623

(22) Filed: Dec. 4, 2006

Related U.S. Application Data
(60) Provisional application No. 60/796,128, filed on Apr. 28, 2006.

(51) Int. Cl. G06F 17/30

(52) U.S. Cl. 707/101

(57) ABSTRACT

A system, method, and computer-readable medium for updating a data structure are provided. A first version of a data structure is registered to receive updates made to a second version of the data structure. The first version of the data structure is associated with a first application and the second version of the data structure is associated with a second application. A value of the second version of the data structure may be updated, and a notification message that includes an identifier of the data structure and the updated value is generated. The notification message is addressed to the first application and transmitted thereto. In response to receiving the notification message, the first version of the data structure is updated.

### BACKGROUND

In multi-processor systems, multiple data structure versions may be deployed. For example, different application versions may use different versions of a common data structure, such as a data repository, database, directory, or the like. It is often desirable to update one data structure version with values from a second version of the data structure.

Centralized mechanisms for updating data structures may be deployed that include version translation functions. A version translation function must maintain version-mapping rules for every version of every data structure that is utilized in the system. Mapping rules may require a significant amount of data storage and processor resources. Disadvantageously, such a mechanism may increase system cost and complexity and may negatively impact overall system performance and reliability. Moreover, centralization of a version translation function creates a bottleneck and a single point of failure.

### BRIEF DESCRIPTION OF THE DRAWINGS

Aspects of the present disclosure are best understood from the following detailed description when read with the accompanying figures, in which:

FIG. 1 is a diagrammatic representation of a multi-processor system in which embodiments disclosed herein may be implemented for performing data structure updates;

FIG. 2 is a diagrammatic representation of an exemplary embodiment of data structures that may be deployed in the system depicted in FIG. 1;

FIG. 3A is a diagrammatic representation of an exemplary subscription repository implemented in accordance with an embodiment;

FIG. 3B is a diagrammatic representation of a notification repository record implemented in accordance with an embodiment;

FIG. 4A is a diagrammatic representation of an exemplary subscription message that is used to register an application of one card to receive notification of updates of a data structure of another card in accordance with embodiments disclosed herein;

FIG. 4B is a diagrammatic representation of an embodiment of an update message comprising an exemplary attribute value pair collection that facilitates data structure updates;

FIG. 5A is a flowchart depicting an embodiment of a registration routine for subscribing an application for notification of updates to a data structure;

FIG. 5B is a flowchart depicting an embodiment of a registration routine for registering an application hosted on another card for notification of updates to a local data structure;

FIG. 6 is a flowchart depicting an embodiment of processing of a notification routine for processing a notification message that indicates a data structure change that has been made on an instance of a data structure of another card; and

FIG. 7 is a flowchart of an embodiment of processing of a notification routine for processing a notification message that does not include an identification of a registered application.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A multi-processor system may include a centralized data structure update mechanism. A centralized data structure update mechanism may be configured for operation with multiple application versions or concurrent operation of multiple applications of a common application version that utilize multiple versions of a common data structure.

A multi-processor system featuring a centralized data structure update mechanism may include a plurality of processor cards that may be communicatively coupled by an interconnect, such as a bus. The processor cards may be implemented as, for example, daughter cards disposed on a backplane of the multi-processor system. The cards may each include one or more respective processors or other instruction execution devices. The processors may run a respective version of a common application. For example, a first processor may run a first version of an application and a second processor may run a second version of the application. The first application version may be compatible with and may utilize a first version of a data structure, and the second version of the application may be compatible with and may utilize a second version of the data structure.

To facilitate exchange of data between the cards, the multi-processor system may feature a centralized data structure version translation function implemented as, for example, a translation engine comprising one or more instruction sets that are executable by a processor. For example, the data structure version translation function may be deployed on a third card that includes one or more processors for execution of the data structure version translation function. The first and second application versions may exchange data structures via the data structure version translation function. For example, the first version of the application may generate or otherwise obtain a first version of the data structure and convey the data structure to the card having the data structure version translation function deployed thereon. The data structure version translation function may then translate the data structure into a second version of the data structure compatible with the second version of the application. The translation function may utilize a data structure version mapping for translation of the data structure. The translated data structure may then be conveyed to the card having the second version of the application.

Disadvantageously, the version translation function must maintain version-mapping rules for every version of every data structure format that is to be handled by the multi-processor system. Consequently, the mapping rules may require a significant amount of data storage and processor resources, which may increase system cost and complexity and may negatively impact overall system performance and reliability. With specific regard to system performance reliability, centralization of the version translation function may create a bottleneck and a single point of failure as all exchanges of data involve and pass through the central version translation function. If the central version translation function fails, the exchange of data between cards and applications may be significantly hindered or completely disabled.

In another implementation, version translation functions may be distributed among processors in a multi-processor system. For example, a first card featuring a first version of an application may include a translation function that may be implemented as a translation engine that is executed by a processor deployed on the first card and may include or interface with an instance of mapping rules deployed on the first card. In a similar manner, a second card featuring a second version of the application may include a translation function implemented as a translation engine that is executed by a processor deployed on the second card and mapping rules deployed on the second card. In this implementation, each card respectively maintains version mapping rules relevant to applications running on the host card and/or other applications in the multi-processor system that share common data structures. In such an implementation, the first card may convey a first version of a data structure to the second card. On receipt of the first version of the data structure by the second card, the data structure is conveyed to the translation function maintained by the second card where it is translated into a second version of the data structure compatible with the second version of the application. Data structure exchanges and translations may be made from the second card to the first card in a similar manner.

Advantageously, a multi-processor system featuring distributed translation functions alleviates bottlenecks and single point of failure issues often exhibited by a centralized version translation system. However, a distributed version translation system requires significant amounts of data storage and processor resources that may increase system cost and complexity and may negatively impact overall system performance and reliability.

In accordance with embodiments disclosed herein, mechanisms for communicating and reconciling multi-versioned data structures in a multi-processor and/or multi-application processing system are provided.

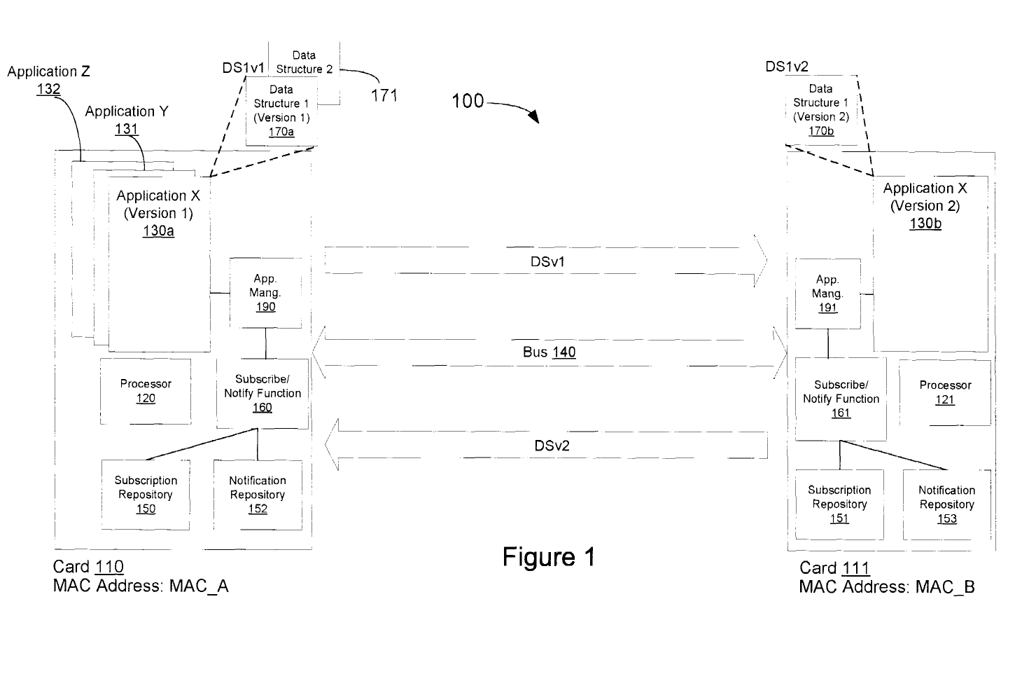

FIG. 1 is a diagrammatic representation of a multi-processor system 100 in which embodiments disclosed herein may be implemented for performing data structure updates. System 100 may include a plurality of processor cards 110-111 communicatively coupled by an interconnect, such as a bus 140. Cards 110-111 may be implemented as daughter cards disposed on a backplane of system 100. Each card 110-111 may have an address associated therewith. In the illustrative example, card 110 has a media access control (MAC) address designated MAC_A, and card 111 has a MAC address designated MAC_B. Cards 110-111 may each include one or more respective processors 120-121 or other instruction execution systems. In the present example, processors 120-121 run version 1 of Application X 130a and version 2 of Application X 130b, respectively. Other applications may also be run on cards 110-111. In the illustrative example, an Application Y 131 and an Application Z 132 are additionally run on card 110.

For illustrative purposes, assume version 1 of Application X 130a is compatible with version 1 (v1) of a data structure 1 (DS1) 170a, and version 2 of Application X 130b is compatible with a version 2 (v2) of data structure 1 170b. Data structures 170a and 170b may be stored on a memory or other storage device of respective card 110-111 or may alternatively be stored on a storage device interfaced with respective cards 110-111. Additionally, another data structure, designated data structure 2 171, is shown included or interfaced with card 110. Cards 110 and 111 may include or interface with a variety of data structures, and those depicted are for illustrative purposes only. Data structures 170a, 170b, and 171 may respectively comprise one or more of a table, an array, an object or object collection, a record or collection of records, a database, or another suitable data construct.

Cards 110 and 111 may include a respective application manager function 190 and 191 configured to transmit data structure updates on bus 140 and to receive data structure updates on bus 140. Data structure updates transmitted and received by manager functions 190 and 191 may comprise attribute value pair (AVPs) that are associated with a particular data structure as described more fully hereinbelow. Manager functions 190 and 191 may be further configured to distribute a received AVP to an application(s) running on the host card of the manager function to facilitate an update thereby.

In accordance with an embodiment, version 1 of Application X 130a and version 2 of Application X 130b interface or are otherwise associated with a respective subscribe/notify function 160 and 161. A subscribe/notify function facilitates registration of a particular application with data structures with which the application is compatible and may further facilitate distribution of an update of a particular data structure specified in one or more AVPs to appropriate applications, e.g., applications registered for updates with the particular data structure.

When an application is initialized or booted, the application may register with the associated subscribe/notify function. During the registration process, the application may declare all data structures that it contains and specifies data structures to which the application is to subscribe, that is receive updates of the subscribed data structure from other applications in system 100. As referred to herein, an application is said to be registered with a data structure when system 100 is configured to provide the application with a notification of changes to another instance of the data structure within system 100. The other data structure instance that the registered application may be notified of changes thereto may comprise a different version of the data structure. To this end, application manger functions 190 and 191 may respectively interface with a subscription repository 150 and 151. Subscription repositories 150 and 151 maintain records of applications and associated data structures with which an application registers to receive updates. In the present example, it is assumed that version 1 of Application X 130a is compatible with data structure version 1 170a, and version 2 of Application X 130b is compatible with data structure 2 170b. Application X 130a may register data structure 170a with subscribe/notify function 160 to receive updates of other instances of data structure 170a, e.g., version 2 of data structure 170b. Accordingly, subscribe/notify function 160 may record an identifier of application X 130 in association with an identifier of data structure 1 (DS1) 170a in subscription repository 150. In a similar manner, version 2 of Application X 130b may register data structure 170b with subscribe notify function 161 to receive updates of other instances of data structure 170b, e.g., updates to version 1 data structure 170a. Accordingly, subscribe/notify function 161 may record an identifier of application X 131 in association with an identifier of data structure 1170b. In one implementation, version 1 of Application X 130a and version 2 of Application X 130b may register and subscribe with subscribe/notify functions 160 and 161 via respective application managers 190 and 191 although Application X 130a and Application X 130b may be configured to interface directly with respective subscribe/notify function 160 and 161.

Once an application has subscribed to receive updates of a particular data structure, the subscribe/notify function may notify other cards of those data structures to which the application has subscribed for updates. For example, upon subscription of Application X 130a with data structure 1 170a, subscribe/notify function 160 may accordingly notify card 111 of the subscription. In one implementation, subscribe/notify function 160 may communication a message to subscribe/notify function 161 that includes an identifier of version 1 of Application X 130a and an identifier of the data structure, e.g., DS1, to which Application X 130a has subscribed for updates. Subscribe/notify function 161 may be adapted to store this subscription information, e.g., in a notification repository 153, and to subsequently send a notification to card 110 when values in the subscribed data structure change on Card 111. In a similar manner, one or more applications on card 111 may subscribe to be notified of updates to a data structure, and subscription information may be maintained in subscription repository 151. Upon subscription of an application to a data structure, subscribe/notify function may notify other cards accordingly. For example, subscribe/notify function 161 may record an identifier of Application X 130b in association with an identifier of data structure 1 170b in subscription repository 151. Thereafter, subscribe/notify function 161 may notify subscribe/notify function 160 of the subscription, and subscribe/notify function 160 may record the subscription information in notification repository 152.

In operation, when a change is made to a data structure on a card, the application manager of the card may detect the data structure change and query the local notification repository, i.e., the notification repository hosted by the card on which the data structure change has been detected, for any applications resident on other cards that have subscribed to be notified of such changes. In the event an application on another card has subscribed to be notified of changes to the data structure for which a change has been detected, the subscribe/notify function may transmit a data structure update notification to the card on which the subscribed application is hosted. In one implementation, the data structure update message transmitted between cards may be formulated as a collection of AVPs as described more fully hereinbelow. In a particular implementation, data structure updates are received by an application manger function, and the receiving application manager function may consult with the local subscription repository to determine which applications of the card receiving the data structure update are to be notified of the data structure update.

In one embodiment, notification of changes in a data structure includes sending one or more AVPs containing updates made to the subscribed data structure as described more fully hereinbelow. In an alternate embodiment, a notification message that is not an AVP may be sent from one card to another which alerts the application hosted by the notified card to a change in data associated with a subscribed data structure. The application, in response to being notified of a change in the data structure, may then choose to request an data structure update from the card on which the change has taken place, and the changes may then be provided via one or more AVPs.

In the depicted example of FIG. 1, applications 130a and 130b and subscription and notification functionality associated therewith are deployed on a card of respective data processing systems. However, in other implementations, applications 130a and 130b may be hosted by respective nodes or data processing systems in a distributed application or server cluster. In such implementations, applications 130a and 130b may be maintained in a respective system memory and run by a processor of the host data processing system. Various other configurations for implementing embodiments disclosed herein are possible as will be recognized by those skilled in the art, and FIG. 1 is intended as an example, and not as an architectural limitation, of embodiments described herein.

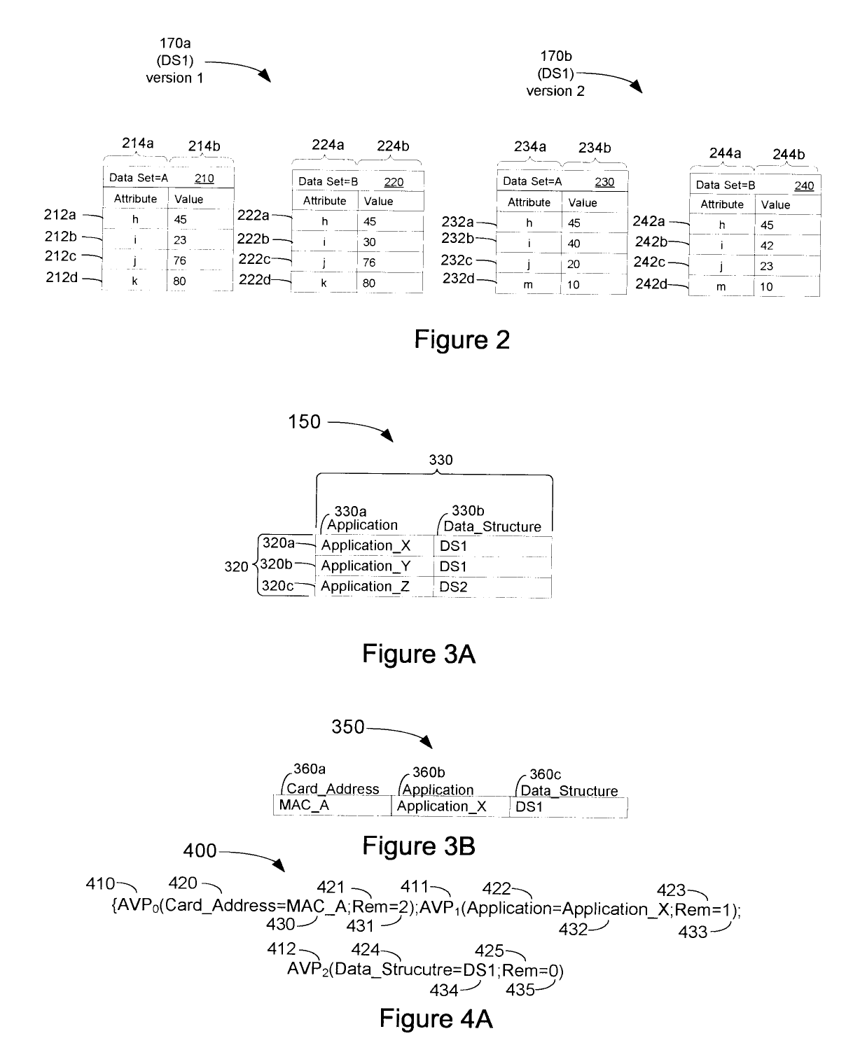

FIG. 2 is a diagrammatic representation of an exemplary embodiment of data structures 170a and 170b. Data structures 170a and 170b may comprise databases or data repositories that may be implemented as, for example, a repository of data objects, tables, data trees or the like. In the present example, data structure 170a comprises data sets 210 and 220 that form a version 1 data structure 170a having a data structure identifier DS1, and data structure 170b comprises data sets 230 and 240 that form a version 2 data structure 170b having a data structure identifier DS1. The identifier DS1 of data structures 170a and 170b may comprise, for example, a file name, a label, or another suitable identifier that may be associated with data structures 170a and 170b. Thus, data structures 170a and 170b respectively comprise separate instances of different versions of a common data structure.

Each of data sets 210-240 may comprise various attributes that may have respective values assigned thereto. In the present example, data set 210 has a data set label of “A” and comprises attribute field 214a that specifies various attributes (illustratively designated “h”-“k”) and an attribute value field 214b that species values of attributes identified in a corresponding records 212a-212d. For example, record 212a of data set 210 defines an attribute “h” that has an attribute value of “45”. Likewise, attributes of “i”, “j”, and “k” have respective values of “23”, “76”, and “80” specified in records 212b-212d. In a similar manner, data set 220 having a label of “B” comprises attribute field 224a that specifies various attributes (illustratively designated “h”-“k”) and an attribute value field 224b that species values of attributes identified in a corresponding record 222a-222d. In the illustrative example, attributes of “h”, “i”, “j”, and “k” of data set 220 have respective values of “45”, “30”, “76”, and “80” specified in records 222a-222d.

Data structure 170b comprises a different version of the data structure defined by data structure 170a. Accordingly, data structure 170b may be configured similar to data structure 170a and may include one or more data sets that correspond to a respective data set of data structure 170a. In the present example, data structure 170b has a corresponding data set 230 and 240 that each comprise different versions of respective data sets 210 and 220 of data structure 170a. Because data structure 170b comprises a different version of data structure 170a, data structure 170b may include or exclude data, such as attributes, that are included in data structure 170a and may include data sets or attributes that are not included in data structure 170a. Additionally, data structure 170a and 170b may share one or more attributes that may have different values assigned thereto. Of course, data set attributes that are common in both data structures 170a and 170b may have a common value assigned thereto. In various scenarios, a value of one instance of a data structure may be changed, and it may be desirable to duplicate the changed value in another instance of the data structure. In the case where a received data structure update contains data elements or attributes that are not defined with respect to the receiving application\data structure, then those data elements or attributes that are not defined with respect to the receiving data structure may simply be ignored by the receiving application\data structure. Conversely, in the case where a received data structure update does not contain all of the data elements or attributes that are defined with respect to the receiving application\data structure, then those data elements or attributes of the receiving application\data structure that have no corresponding data elements or attributes in the received data structure update may be left unchanged or may be set to a default value. In accordance with embodiments, a notification may be provided to an application that uses a first instance of a data structure when a change is made to another instance of the data structure. The application may then replicate the change in the first instance of the data structure. The first instance of the data structure and the second instance of the data structure may comprise different versions of a data structure. Accordingly, embodiments disclosed herein provide mechanisms for reconciling multi-versioned data structures is provided.

In the present example, data structure 170b comprises data sets 230 and 240 that have a respective label of “A” and “B”. Data set 230 comprises attribute field 234a that specifies various attributes (illustratively designated “h”-“j” and “m”) and an attribute value field 234b that species values of attributes identified in a corresponding record 232a-232d. Particularly, attributes of “h”, “i”, “j”, and “m” have respective values of “45”, “40”, “20”, and “10” specified in records 232a-232d. In a similar manner, data set 240 comprises attribute field 244a that specifies various attributes (illustratively designated “h”-“j” and “m”) and an attribute value field 244b that species values of attributes identified in a corresponding record 242a-242d. In the illustrative example, attributes of “h”, “i”, “j”, and “m” have respective values of “45”, “42”, “23”, and “10” specified in records 242a-242d.

FIG. 3A is a diagrammatic representation of an exemplary subscription repository 150 implemented in accordance with an embodiment. Repository 150 comprises a plurality of records 320a-320c (collectively referred to as records 320) and fields 330a-330b (collectively referred to as fields 330) that maintain application data structure subscription information. Repository 150 may be stored on a disk drive or other storage device, fetched therefrom by a processor, and processed thereby. In the present example, repository 150 comprises a table although other data structures may suitably be substituted therefore.

Fields 330a-330b have a respective label, or identifier, that facilitates insertion, deletion, querying, or other data operations or manipulations of repository 150. In the illustrative example, fields 330a-330b have respective labels of “Application” and “Data_Structure.”

Data elements of field 330a identify an application that is registered for data structure updates, and data elements of field 330b identify a particular data structure for which the application specified in field 330a of a corresponding record is registered for updates. For example, record 320a defines a data structure update registration for “Application_X” with data structure “DS1”, e.g., data structures 170a and 170b. In a similar manner, records 320b-320c define a respective data structure update registration for “Application_Y” and “Application_Z” with data structures “DS1” and “DS2”.

FIG. 3B is a diagrammatic representation of a notification repository record 350 implemented in accordance with an embodiment. Record 350 may be maintained in a notification repository, e.g., notification repository 153 depicted in FIG. 1, and facilitates notification of data structure updates to applications hosted by other cards. Notification repositories 152 and 153 may store a plurality of notification repository records, and record 350 is depicted to facilitate an understanding of embodiments disclosed herein.

Record 350 comprises a plurality of fields 360a-360c (collectively referred to as fields 360) that maintain data necessary for notification of an application of a data structure update. Fields 360a-360c have a respective label, or identifier, that facilitates insertion, deletion, querying, or other data operations or manipulations of record 350. In the illustrative example, fields 360a-360c have respective labels of “Card_Address,” “Application,” and “Data_Structure.”

A data element of Card_Address field 360a specifies a card address so that data structure updates may be properly addressed and transmitted to the card. In the present example, field 360a specifies a card address of “MAC_A,” that is the media access control address illustratively designated for card 110 in FIG. 1. While a media access control address is depicted as specifying a card address in record 350, other addresses, such as a bus address, a LAN address, an IP address, or another suitable address may be substituted therefor or used in combination with a physical address of the card.

A data elements of field 360b specifies a particular application that has subscribed to receive data structure updates. In the present example, the application specified in Application field 360b is “Application_X.” A data element of field 360c species a particular data structure that the application specified in field 360b has subscribed to receive updates. In the illustrative example, field 360c stores a value of “DS1” thereby indicating that Application_X has subscribed to receive notification of updates made to the data structure with a data structure identifier of DS1. In the examples provided herein, assume record 350 is stored in notification repository 153 of card 111. Data structure 170b hosted or interface by card 111 has an identifier of DS1, and thus record 350 comprises a directive for card 111 to notify Application_X of card 110 of any updates made to data structure 170b of card 111.

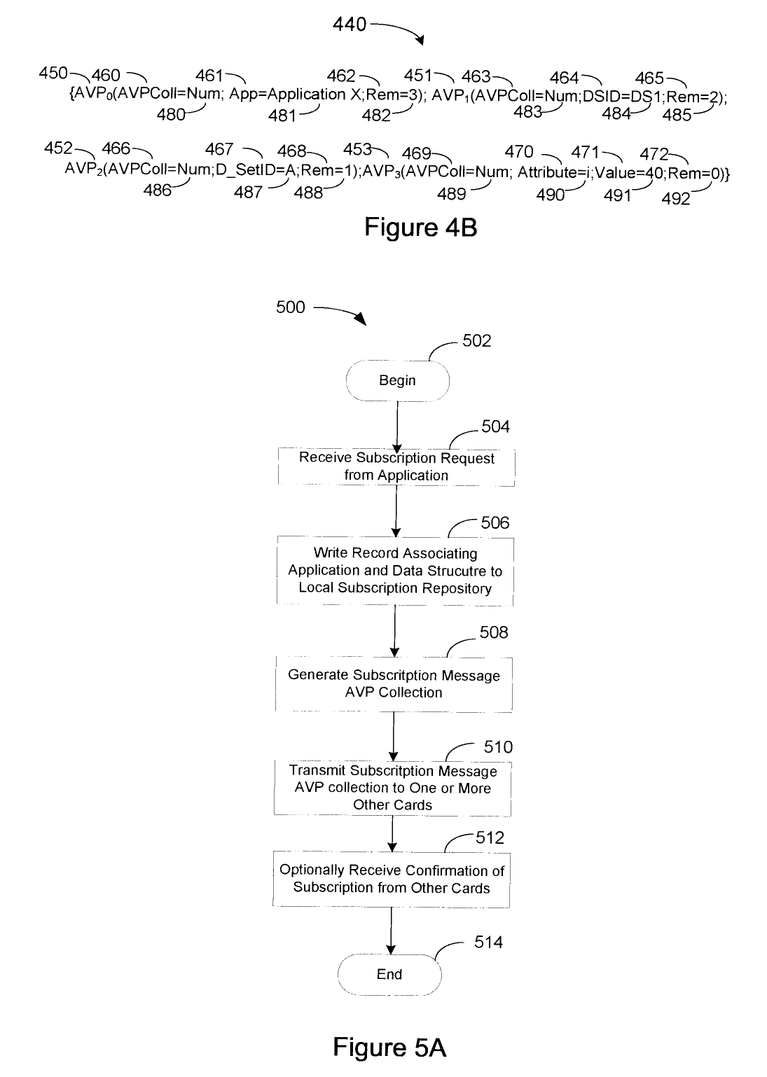

FIG. 4A is a diagrammatic representation of an exemplary subscription message that is used to register an application of one card to receive notification of updates of a data structure of another card in accordance with embodiments disclosed herein. The depicted subscription message may comprise an AVP collection 400 that includes one or more AVPs, and in the depicted example AVP collection 400 comprises AVPs 410-412 each having one or more fields 420-425 each having a value 430-435 assigned thereto.

In the illustrative example, AVP element 410 includes a field 420 having a label of Card_Address and a value 430 (illustratively designated “MAC_A”) assigned thereto. Value 430 specifies an address of the particular card hosting the application for which AVP collection 400 specifies a data structure update subscription. In the present example, card 110 has an address of “MAC_A”, and thus AVP collection 400 specifies a subscription message for an application hosted by card 110. Additionally, AVP element 410 includes a field 421 having a label of Rem with a value 431 assigned thereto that specifies the number of remaining AVP elements that follow AVP element 410. In the illustrative example, value 431 specifies that 2 additional AVP elements follow AVP element 410 in collection 400. Alternatively, value 431 assigned to Rem field 421 may specify a number of remaining packets of AVP collection 400.

AVP element 411 includes a field 422 having a label of Application and a value 432 (illustratively designated “Application_X”) assigned thereto. Value 432 specifies the particular application for which AVP collection 400 defines a data structure update subscription. Thus, in the present example, AVP collection 400 specifies a subscription message for Application X 130 hosted by card 110. In the event that the registered application is run in a host memory, AVP collection 400 may additionally include a field for storing a port designation, or other logical association, assigned to the registered application. Alternatively, a port designation or other logical association of the application manager associated with the registered application may be included in AVP collection 400. In this manner, a notification message may be directly addressed to the registered application or the application manager associated therewith. Additionally, AVP element 411 includes a field 423 having a label of Rem with a value 433 assigned thereto that specifies the number of remaining AVP elements that follow AVP element 411. In the illustrative example, value 433 specifies that 1 additional AVP element follows AVP element 411 in collection 400.

AVP element 412 includes a field 424 having a label of Data_Structure and a value 434 (illustratively designated “DS1”) assigned thereto. Value 434 specifies the particular data structure for which update notifications are to be provided to the application of the card specified by fields 422 and 420, respectively. Thus, in the present example, notifications of updates to the data structure having an identifier DS1, i.e., data structure 170b, are to be provided to Application_X of card 110. Additionally, AVP element 412 includes a field 425 having a label of Rem with a value 435 assigned thereto that specifies the number of remaining AVP elements that follow AVP element 412. In the illustrative example, value 435 specifies that no additional AVP elements follow AVP element 412 in collection 400, that is value 435 indicates that AVP element 412 is the final AVP element of AVP collection 400.

FIG. 4B is a diagrammatic representation of an embodiment of an update notification message comprising an exemplary attribute value pair collection 440 that facilitates data structure updates. AVP collection 440 may comprise a plurality of AVP elements 450-453 (illustratively designated AVP₀-AVP₃) each having one or more fields 460-472 and respective field values 480-492 assigned thereto.

In the illustrative example, AVP element 450 includes a field 460 having a label of AVPColl and a value 480 (illustratively designated “Num”) assigned thereto. Value 480 specifies an AVP collection identifier assigned to AVP collection 440 to distinguish content of AVP collection 440 from other AVP collections to facilitate correlation of content of AVP collection 440. For example, the value of “Num” assigned to value 480 of AVPColl field 460 may comprise a 16-bit, 32-bit, or other suitable numerical identifier commonly assigned to each of AVP elements 450-453 of AVP collection 440. Additionally, AVP element 450 includes a field 461 having a label of App with a value 481 assigned thereto that specifies an application to which AVP collection 440 is applicable. In the illustrative example, App field 461 has a value 481 of “Application X” thus indicating that AVP collection 440 is applicable to, for example, Applications_X 130a. App field 461 servers to facilitate addressing and transmitting the notification message to a registered application. In the event that the registered application is run in a host memory, AVP collection 440 may additionally include a field for storing a port designation, or other logical association, assigned to the registered application or, alternatively, the application manager associated with the registered application. In this manner, a notification message may be directly addressed to the registered application or the application manager associated therewith. Additionally, AVP element 450 includes a field 462 having a label of Rem with a value 482 assigned thereto that specifies the number of remaining AVP elements that follow AVP element 450. In the illustrative example, value 482 specifies that 3 additional AVP elements follow AVP element 450 in collection 440. Alternatively, value 482 assigned to Rem field 462 may specify a number of remaining packets of AVP collection 440.

AVP element 451 includes a field 463 having a label of AVPColl and a value 483 assigned thereto. Value 483 specifies the AVP collection identifier assigned to each AVP element 450-453 of AVP collection 440 as discussed above with regard to value 480 assigned to field 460 of AVP element 450. Additionally, AVP element 451 includes a field 464 having a label of DSID with a value 484 assigned thereto that specifies a data structure identifier of a particular data structure for which AVP collection 440 is applicable. In the illustrative example, DSID field 464 has a value 484 of “DS1” thus indicating that AVP collection 440 is applicable to a data structure with a label or other identifier of DS1. Additionally, AVP element 451 includes field 465 having a label “Rem” with a value 485 assigned thereto that specifies the number of remaining AVP elements, packets, or another length metric that indicates the amount of content remaining in AVP collection 440 that follows AVP element 451. In the present example, Rem field 465 has a value 485 of “2” thereby indicating that two AVP elements 452-453 follow AVP element 451.

AVP element 452 includes a field 466 having a label of AVPColl having a value 486 assigned thereto. Value 486 specifies the AVP collection identifier assigned to each AVP element 450-453 of AVP collection 440 as discussed above with regard to value 480 assigned to field 460 of AVP element 450. Additionally, AVP element 452 includes a field 467 having a label of D_SetID with a value 487 assigned thereto that specifies a data set identifier of a particular data set for which AVP collection 440 is applicable. In the illustrative example, D_SetID field 467 has a value 487 of “A” thus indicating that AVP collection 440 is applicable to a data set with a label or other identifier of “A”. Additionally, AVP element 452 includes field 468 having a label “Rem” with a value 488 assigned thereto that specifies the number of remaining AVP elements, packets, or another length metric that indicates the amount of content remaining in AVP collection 440 that follows AVP element 452. In the present example, Rem field 468 has a value 488 of “1” thereby indicating that a single AVP element 453 follows AVP element 452.

AVP element 453 includes a field 469 having a label of AVPColl having a value 489 assigned thereto. Value 489 specifies the AVP collection identifier assigned to each AVP element 450-453 of AVP collection 440 as discussed above with regard to value 480 assigned to field 460 of AVP element 450. Additionally, AVP element 453 includes a field 470 having a label of Attribute with a value 490 assigned thereto that specifies a particular attribute for which AVP collection 440 is applicable. In the illustrative example, Attribute field 470 has a value 490 of “i” thus indicating that AVP collection 440 is applicable to an attribute i. Additionally, AVP element 453 includes field 471 having a label of Value with a value 491 assigned thereto that specifies a particular value of the attribute specified by field 471. In the present example, the attribute i has a value of 40 as specified by field value 491. Additionally, AVP element 453 includes field 472 having a label “Rem” with a value 492 assigned thereto that specifies the number of remaining AVP elements, packets, or another length metric that indicates the amount of content remaining in AVP collection 440 that follows AVP element 453. In the present example, Rem field 472 has a value 492 of “0” thereby indicating that AVP element 453 is the final AVP element of AVP collection 440.

In accordance with an embodiment, application manager 190-191 respectively associated with applications 130a-130b may issue an AVP collection similar to that depicted in FIG. 4B to facilitate a data structure update on another card. On receipt of an AVP collection by application manger 190-191, the receiving application manager may evaluate a field of a particular AVP element, e.g., field 461 and associated field value 481 of AVP element 450, to determine to which application the AVP collection is targeted or addressed. The application manager function may then direct the received AVP collection to the recipient application.

In an alternate embodiment, an AVP collection may not specify a target application, but rather the application manager function may be adapted to receive a collection of AVP packets associated with a data structure update and subsequently consult with an associated subscribe/notify function in order to determine which registered applications the received AVP collection is relevant. The application manager function may then make copies of the received AVP collection and distribute the copies to each application that has subscribed to updates for the associated data structure.

One advantage of the AVP collection approach for facilitating data structure updates is that large amounts of data associated with a data structure update may be broken down and packaged for internal transport within many small AVP packets or elements. In certain system implementations, this ability may be very advantageous with respect to internal network resource utilization. For example, transmit/re-transmit buffer sizes may be reduced due to the smaller AVP message sizes. Additionally, in cases of internal transmission errors, retransmission of a few, relatively small AVP packets associated with an AVP collection, is less resource intensive compared to re-transmission of a large AVP message.

In other implementations, a monolithic AVP messaging approach may be implemented. That is, instead of communicating a data structure update using a collection of multiple, small AVP packets or elements, a single AVP packet or element may be used to convey all of the information necessary to provide the data structure update details. For example, a monolithic AVP packet may include information that specifies the target or recipient application, information that identifies the associated data structure, information that identifies the associated data set, and information that identifies the associated data element/attribute and corresponding attribute value. The functionality of the application manager as described above with regard to AVP collection 440 may be adapted to accommodate the monolithic AVP implementation.

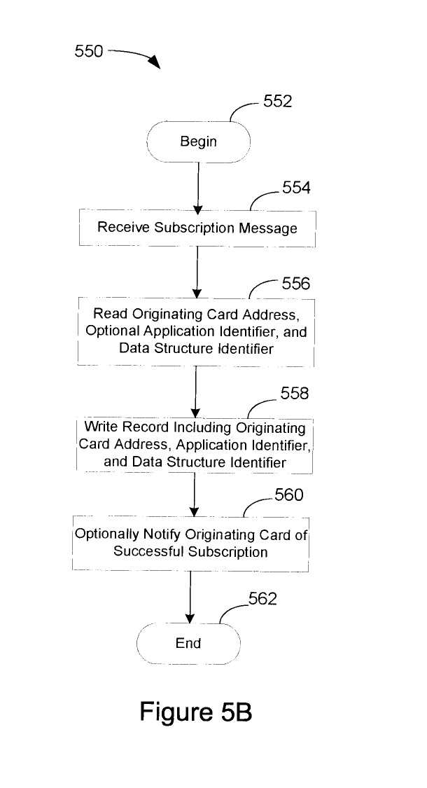

FIG. 5A is a flowchart 500 depicting an embodiment of a registration routine for subscribing an application for notification of updates to a data structure. The registration routine is invoked (step 502), and a subscription request is received from an application (step 504). A record is then written to the local subscription repository that associates the application from which the subscription request was received and the data structure with which the application is to be registered (step 506). A subscription message AVP collection may then be generated (step 508) and subsequently transmitted to one or more other cards (step 510). A confirmation that the subscription request was received and processed by the other card(s) to which the subscription message AVP collection was transmitted may optionally be received by the card that issued the request (step 512), and the registration routine processing cycle may then end (step 514).

As an example, assume Application X 130 is compatible with or otherwise uses version 1 of data structure 170a. On initialization or boot of Application X 130, Application X 130 may issue a subscription request to subscribe/notify function 160. The subscription request indicates that Application X 130 is to be notified of updates to other instances, including different versions thereof, of data structure 170a that may be hosted by other cards. On receipt of the subscription request by subscribe/notify function 160, subscribe/notify function 160 may add a record to local subscription repository 150 that associates Application X with an identifier, e.g., an identifier DS1, of data structure 170a. For example, subscribe/notify function 160 may write record 320a depicted in FIG. 3 to subscription repository 150 to register Application X as a subscriber to updates made to data structure DS1. Subscribe/notify function 160 may then generate a subscription message similar to that depicted in FIG. 4A and transmit the subscription message to subscribe/notify functions of other cards, e.g., subscribe/notify function 161 of card 111. Subscribe/notify function 161 may record the subscription and may optionally notify the originating card thereof.

FIG. 5B is a flowchart 550 depicting an embodiment of a registration routine for registering an application hosted on another card for notification of updates to a local data structure. The registration routine is invoked (step 552), and a subscription message such as that depicted in FIG. 4A is received by a subscribe/notify function (step 554). The receiving subscribe/notify function may then read, from the subscription message, a card address of the card hosting the subscribe/notify function that originated the subscription message, and may read an application identifier of an application being registered as a subscriber of updates to a data structure specified in the subscription message (step 556). Additionally, the subscribe/notify function that has received the subscription message may read an identifier of the data structure to which the subscribing application is to be registered to receive update notifications. Upon having read the address of the card from which the subscription message originated, the Application identifier, and the data structure identifier, the subscribe/notify function that has received the subscription message may write a record to the local notification repository (step 558). The record written to the local notification repository records the address of the card from which the subscription originated, an optional identifier of the registered application, and an identifier of the data structure. The subscribe/notify function may optionally notify the originating subscribe/notify function that the registration has been completed (step 560), and the registration routine cycle may then end (step 562).

As an example, assume that subscribe/notify function 161 receives a subscription message 400 from subscribe/notify function 160. Subscribe/notify function 161 may read the address of card 110, the application identifier, and the data structure identifier from the subscription message and generate a notification record similar to that depicted in FIG. 3B. The notification record may then be written to the local notification repository, e.g., notification repository 153 depicted in FIG. 1. Accordingly, a notification of any changes to data structure 170b having an identifier DS1 made on card 111 may be conveyed to card 110 as described more fully hereinbelow.

When a change is made to a data structure, e.g., data structure 170b, on one card with which an application of another card has been registered to receive notification of an update, the card on which the data structure has been changed may generate an update message similar to that depicted in FIG. 4B. The card on which the data structure has been changed may then transmit the notification message to any cards having an application registered to receive the change in the local notification repository of the card.

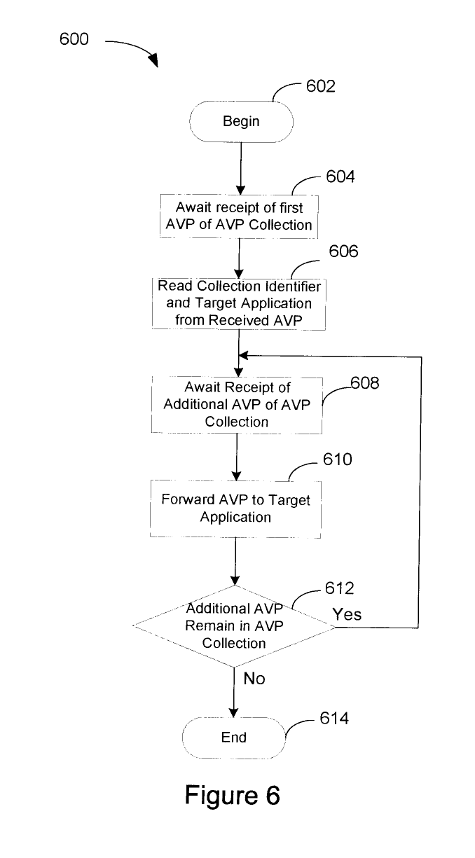

On receipt of a notification message by a card, a notification routine may process the notification message to facilitate update of local version of the data structure that has another instance that has been changed on the card that issued the notification message. FIG. 6 is a flowchart 600 depicting an embodiment of processing of a notification routine for processing a notification message that indicates a data structure change that has been made on an instance of a data structure of another card. The notification routine is invoked (step 602), and the notification routine awaits receipt of a first AVP of an AVP collection that defines a notification message (step 604). On receipt of the first AVP of an AVP collection, a collection identifier and application identifier may be read from the received AVP collection (step 606).

The notification routine may then await receipt of the next AVP of the AVP collection (step 608), and subsequently forward the received AVP to the target application (step 610). An evaluation may then be made to determine if additional AVPs remain in the AVP collection (step 612). If any additional AVPs of the AVP collection remain to be received, the notification routine may return to step 608 to await receipt of another AVP of the AVP collection. Once all AVPs of the AVP collection have been received, the notification routine cycle may end (step 614).

As an example, assume that Application X 130 hosted by card 110 has successfully been registered as a subscriber to receive notifications of changes made to data structure DS1. Accordingly, card 110 will maintain a record, such as record 320a, in subscription repository 150 that associates Application X 130 with the data structure DS1. In a similar manner, a record, such as record 350, will be maintained in notification repository 153 of card 111 that maintains an address of card 110 hosting registered Application X 130, an optional identification of the registered application, and an identifier of the data structure with which Application X 130 is registered.

In the present example, assume that Application X 131 on card 111 has changed the value of attribute “i” of data set “A” from “23” to “40” in data structure 170b (data structure DS1). Upon detection of the change to data structure 170b, application manager function 191 may invoke subscribe/notify function 161 to determine if any cards are to be notified of the change. Subscribe/notify function 161 may, in turn, interrogate notification repository 153 and determine that Application X 130 hosted by card 110 is to be notified of the change. Accordingly, subscribe/notify function 161 may generate a notification message, such as a notification message comprising AVP collection 440 depicted in FIG. 4B, and transmit the notification message to card 110, i.e., to the address specified in field 360a of record 350. Application manger function 190 may then receive each AVP 410-413 of AVP collection 440, and subsequently forward the AVP collection 440 to the target application, i.e., Application X 130, specified thereby. Application_X 130 may then update the data set “A” attribute “i” value to “40” in data structure 170a as specified in AVP collection 440.

In some implementations, the target application may not be explicitly identified in a notification message. For example, field 461 and associated value 481 of AVP collection 400 depicted in FIG. 4B may be excluded from the notification message specified by AVP collection 440. In this implementation, another notification processing routine may be implemented to accommodate application notification of updates to data structures.

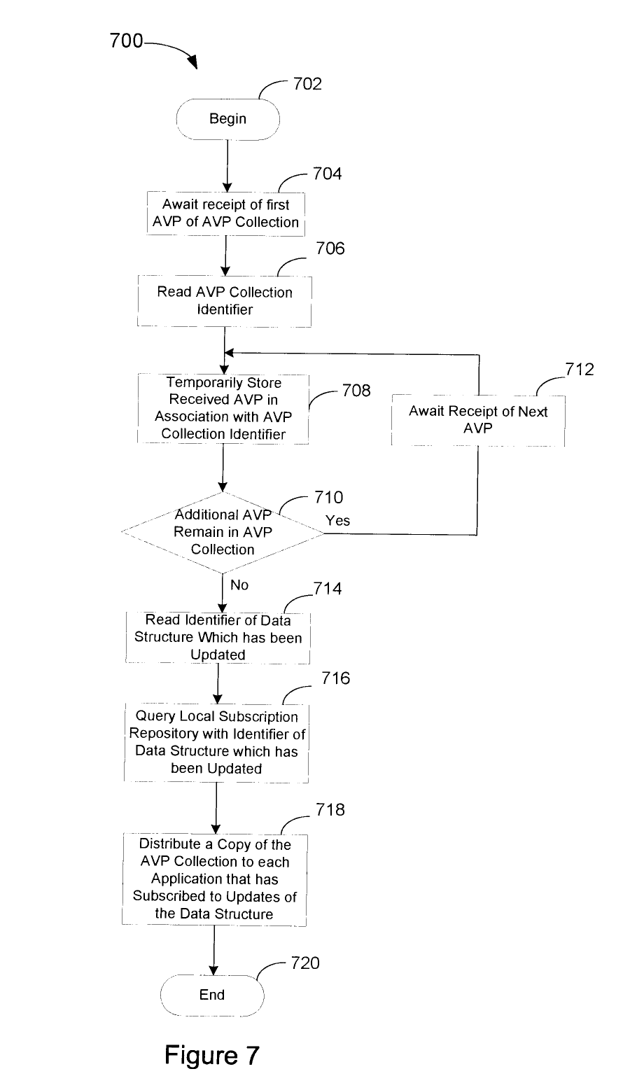

FIG. 7 is a flowchart 700 of an embodiment of processing of a notification routine for processing a notification message that does not include an identification of a registered application. The notification routine is invoked (step 702), and awaits receipt of a first AVP of an AVP collection (step 704). An AVP collection identifier may be read from the received AVP (step 706), and the AVP may then be temporarily stored in association with the AVP collection identifier (step 708). An evaluation may then be made to determine if additional AVPs of the AVP collection remain to be received (step 710). If additional AVPs remain, the notification routine may proceed to await receipt of the next AVP of the AVP collection (step 712).

After receipt of all AVPs of an AVP collection, an identifier of the data structure that has been updated may be read from the AVP collection (step 714). The local subscription repository may then be queried with the data structure identifier to identify any applications that have registered to receive updates to the data structure specified in the received AVP collection (step 716). A copy of the AVP collection may then be distributed to any applications identified as being registered to receive updates of the data structure identified in the AVP collection (step 718). The notification routine cycle may then end (step 720).

In the present example, assume that Application X 131 on card 111 has changed the value of attribute “i” of data set “A” from “23” to “40” in data structure 170b (data structure DS1). Upon detection of the change to data structure 170b, application manager function 191 may invoke subscribe/notify function 161 to determine if any cards are to be notified of the change. Subscribe/notify function 161 may, in turn, interrogate notification repository 153 and determine that Application_X 130 hosted by card 110 is to be notified of the change. Accordingly, subscribe/notify function 161 may generate a notification message that includes an identifier of the data structure, data set, attribute, and attribute value but that excludes an identifier of the application registered to receive the data structure update. The notification message may then be transmitted to card 110, i.e., to the address specified in field 360a of record 350. Application manger function 190 may then receive an AVP of the AVP collection included in the notification message, read the AVP collection identifier, and temporarily store each AVP in association with the AVP collection identifier until the complete AVP collection has been received. Application manager function 190, upon reception of the complete AVP collection, may then read the data structure identifier from the AVP collection and subsequently interrogate subscription repository 150 with the data structure identifier. In the present example, assume application manager function 190 interrogates subscription repository 150 with the data structure identifier “DS1”. As depicted in FIG. 3A, an identifier of Application_X and Application_Y is returned to application manger function 190. Accordingly, application manger function 190 may then forward a copy of the received AVP to Application_X 130a and Application_Y 131. In this instance, either of Application_X 130a and Application_Y 131 may write the updated value of the data structure attribute value specified in the notification message to data structure 170a.

The flowcharts of FIGS. 5A-7 depict process serialization to facilitate an understanding of disclosed embodiments and are not necessarily indicative of the serialization of the operations being performed. In various embodiments, the processing steps described in FIGS. 5A-7 may be performed in varying order, and one or more depicted steps may be performed in parallel with other steps. Additionally, execution of some processing steps of FIGS. 5A-7 may be excluded without departing from embodiments disclosed herein. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific descriptions provided herein based on, for example, considerations of function, purpose, conformance to standard, legacy structure, and the like.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, network stack, or any combination thereof, executing on a single computer processor or multiple computer processors. Additionally, various steps of embodiments of the invention may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure.

What is claimed is:

1. A method of updating a data structure, comprising:
registering a first version of a data structure to receive updates made to a second version of the data structure, wherein the first version of the data structure is associated with a first application and the second version of the data structure is associated with a second application;
updating a value of the second version of the data structure;
generating a notification message that includes an identifier of the data structure and the updated value, wherein the notification message is addressed to the first application;
transmitting the notification message to the first application; and
in response to receiving the notification message, updating the first version of the data structure.

2. The method of claim 1, wherein the first application is hosted by a first card and the second application is hosted by a second card, and wherein registering the first version further comprises recording, by the second card, an address of the first card and an identifier of the first application.

3. The method of claim 2, further comprising receiving a subscription message from the first card, wherein the subscription message includes the address of the first card and the identifier of the first application.

4. The method of claim 2, wherein registering the first version further comprises recording an identifier of the data structure, wherein the address of the first card, the identifier of the first application, and the identifier of the data structure are recorded in association with one another.

5. The method of claim 1, wherein the second application comprises a second instance of the first application.

6. The method of claim 1, wherein the first application and the second application respectively comprise first and second instances of a common application deployed in an application cluster.

7. The method of claim 1, wherein the value comprises a value of an attribute of the second version of the data structure.

8. A computer-readable medium having computer-executable instructions for execution by a processing system, the computer-executable instructions for updating a data structure, comprising:
instructions that register a first version of a data structure to receive updates made to a second version of the data structure, wherein the first version of the data structure is associated with a first application and the second version of the data structure is associated with a second application;
instructions that update a value of the second version of the data structure;
instructions that generate a notification message that includes an identifier of the data structure and the updated value, wherein the notification message is addressed to the first application;
instructions that transmit the notification message to the first application; and
instructions that, in response to receiving the notification message, update the first version of the data structure.

9. The computer-readable medium of claim 8, wherein the first application is hosted by a first card and the second application is hosted by a second card, and wherein the instructions that register the first version further comprise instructions hosted by the second card that record an address of the first card and an identifier of the first application.

10. The computer-readable medium of claim 9, further comprising instructions that receive a subscription message from the first card, wherein the subscription message includes the address of the first card and the identifier of the first application.

11. The computer-readable medium of claim 9, wherein the instructions that register the first version further comprise instructions that record an identifier of the data structure, the address of the first card, and the identifier of the first application in association with one another.

12. The computer-readable medium of claim 8, wherein the second application comprises a second instance of the first application.

13. The computer-readable medium of claim 8, wherein the first application and the second application respectively comprise first and second instances of a common application deployed in an application cluster.

14. The computer-readable medium of claim 8, wherein the value comprises a value of an attribute of the second version of the data structure.

15. A distributed processing system, comprising:
a first application that interfaces with a first version of a data structure that includes a first instance of a data element;
a second application that interfaces with a second version of the data structure that includes at second instance of the data element; and
a subscription repository that stores a record including an identifier of the first application and an identifier of the data structure, wherein, in response to an update made to the second instance of the data element, a notification message is generated that is addressed to the first application and that includes an identifier of the data structure and the updated value, wherein the notification message is transmitted to the first application, and wherein the first instance of the data element is updated with the updated value.

16. The distributed processing system of claim 15, wherein the first application is hosted by a first card of a data processing system and the second application is hosted by a second card of a data processing system, wherein the notification message is addressed to the first card.

17. The distributed processing system of claim 15, further comprising an application manager associated with the second application, wherein the application manager is adapted to transmit the notification message when the update is made to the second instance of the data element.

18. The distributed processing system of claim 17, further comprising an application manager associated with the first application adapted to determine the first application is registered to receive the notification message.

19. The distributed processing system of claim 15, wherein the notification message comprises an attribute value pair collection.

20. The distributed processing system of claim 15, wherein the first instance of the data element comprises a first instance of an attribute of the first version of the data structure, and wherein the second instance of the data element comprises a second instance of the attribute of the second version of the data structure.

21. The distributed processing system of claim 15, wherein the first application and the second application are deployed in an application cluster.
